(19) United States
(12) Patent Application Publication
(10) Pub. No.: US 2023/0069808 A1
(43) Pub. Date: Mar. 2, 2023

(54) KIT FOR CONTACTLESS TERPENE INFUSION

(71) Applicant: Synergy Research Group, Inc., North Hollywood, CA (US)

(72) Inventors: Mike Schneider, Sherman Oaks, CA (US); Steve Lee, La Canada, CA (US)

(73) Assignee: Synergy Research Group, Inc., North Hollywood, CA (US)

(21) Appl. No.: 17/459,140

(22) Filed: Aug. 27, 2021

(51) Int. Cl. B65D 85/804; A24B 15/30

(52) U.S. Cl. CPC B65D 85/8043; A24B 15/303

(57) ABSTRACT

A kit is configured to perform contactless terpene infusion of one or more cannabis materials. The kit includes a terpene composition. Furthermore, the kit includes a carrier medium that is configured to at least partially absorb the terpene composition upon making contact with the terpene composition. Finally, the kit includes a removable tray adapted to (i) fit within a top portion of a container, (ii) receive the carrier medium, (iii) prevent the carrier medium from contacting the one or more cannabis materials situated within a bottom portion of the container, and (iv) infuse the one or more cannabis materials with an aroma from the carrier medium subsequent to the at least partial absorption of the terpene composition.

### BACKGROUND

### 1. Field

This disclosure generally relates to terpene infusion into cannabis materials. More particularly, the disclosure relates to a kit adapted to perform contactless terpene infusion into cannabis materials.

### 2. General Background

Terpenes are hydrocarbon compounds found in a variety of plants, some of which are cannabis and some of which are not. In particular, terpenes are recognized for their ability to emit a strong aroma of varying scents, depending upon the particular terpene strain. With respect to cannabis, terpenes emit such scents to deter would-be attackers, such as herbivores, from eating the plant, or attract those who are more interested in eating the attackers, such as carnivores.

Furthermore, many cannabis plant growers tend to grow cannabis in a way that strengthens the potency of tetrahydrocannabinol (“THC”), which typically has the psychoactive effect of producing a sense or euphoria in a human being, the result of THC binding with cannabinoid 1 (“CB1”) receptors in the brain. Cannabis plants with a higher potency of THC than others also tend to have the terpenes that emit a smell typically considered to be a desirable aroma to many users of cannabis.

While being grown, cannabis may lose some, if not all, of the aroma associated with its terpenes. The aroma may be lost, or diminished, based on a variety of factors (e.g., seed selection, sub-optimal growing environment, etc.).

As a result, current apparatuses and processes do not adequately maintain the natural aroma from cannabis after being grown.

### SUMMARY

In one aspect of the disclosure, a kit is configured to perform contactless terpene infusion for one or more cannabis materials. The kit includes a terpene composition. Furthermore, the kit includes a carrier medium that is configured to at least partially absorb the terpene composition upon making contact with the terpene composition. Finally, the kit includes a removable tray adapted to (i) fit within a top portion of a container, (ii) receive the carrier medium, (iii) prevent the carrier medium from contacting the one or more cannabis materials situated within a bottom portion of the container, and (iv) infuse the one or more cannabis materials with an aroma from the carrier medium subsequent to the at least partial absorption of the terpene composition.

In another aspect of the disclosure, the kit also includes a storage apparatus that has a bottom portion, a wall integrally formed to surround the bottom portion, and to extend upward from the bottom portion, a top portion that is removable from the storage apparatus, and a removable tray. The top portion is in contact with the wall during closure of the storage apparatus.

In yet another aspect of the disclosure, the kit includes the carrier medium and the removable tray, without the terpene composition.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates an example of a kit configuration that may be utilized for contactless terpene infusion.

FIG. 2 illustrates the kit configuration as removed from the package.

FIG. 3 illustrates a terpene solution being poured from a terpene composition container onto the carrier media within the carrier media container.

FIG. 4 illustrates a storage apparatus that may be utilized in conjunction with the kit illustrated in FIG. 1.

FIG. 5 illustrates the plurality of carrier media being poured into the removable tray.

FIG. 6 illustrates the plurality of carrier media emitting a terpene aroma downward within the storage apparatus toward the one or more cannabis materials.

FIG. 7 illustrates an example of another kit configuration that may be utilized for contactless terpene infusion.

FIG. 8 illustrates a terpene solution being poured from a terpene composition container onto the absorbent paper within the carrier media container.

FIG. 9 illustrates the absorbent paper emitting a terpene aroma downward within the storage apparatus toward the one or more cannabis materials.

FIG. 10 illustrates the absorbent paper having a circular shape.

### DETAILED DESCRIPTION

A kit is configured to perform contactless terpene infusion for one or more cannabis materials. In particular, the kit may be used in conjunction with a separately provided (or potentially part of the kit) storage apparatus that stores one or more cannabis materials (e.g., cannabis flowers, leaves, etc.). For example, the storage apparatus may be a wide mouth mason jar, although other types of storage apparatuses may be used instead. One or more cannabis materials are stored at the bottom of the storage apparatus. The kit includes a removable tray, which is adapted to connect to the top portion of the storage apparatus. For example, the removable tray may have a lip that mates with the rim of the storage apparatus. As a result, the removable tray allows for a carrier medium for a terpene composition to lie above the cannabis materials without making contact with such materials beneath it, which could damage them. Thus, the kit allows for contactless terpene infusion.

Furthermore, the kit solves not only the problem of avoiding damage to cannabis materials during the terpene infusion process, but also the problem of providing optimal delivery of the aroma stemming from the terpene composition. Particularly, the kit is configured to provide such contactless terpene infusion in a downward direction toward the cannabis materials. Also, the kit may have apertures that are sized and/or shaped to accommodate carrier media to optimize delivery of the aroma via contactless terpene infusion.

In essence, the storage apparatus allows for storage of the one or more cannabis materials prior to use, while also infusing the one or more cannabis materials with an aroma to improve the smell and/or taste of the one or more cannabis materials during use. Accordingly, the storage apparatus may be adapted for olfactory, and/or gustatory, use with one or more cannabis materials. Therefore, the one or more cannabis materials may remain dry (i.e., moisture-free) during absorption by the carrier medium of the terpene composition within the removable tray.

In one embodiment, the kit may have the removable tray and a container with one or more carrier media. One example of a carrier medium is an expandable bead that is capable of absorbing the terpene solution. Another example of the carrier medium is an absorbent paper. In another embodiment, the kit also includes a container with the terpene solution, but the storage apparatus is provided separately from the kit. Finally, in yet another embodiment, the kit includes the container with the removable tray, the plurality of carrier media, the container with the terpene solution, and the storage apparatus.

Furthermore, a terpene infusion process may be performed by the end-user to prepare the kit for terpene infusion. For example, the end-user may pour the terpene solution into the container for the one or more carrier media to allow the one or more carrier media to absorb the terpene solution prior to pouring the plurality of carrier media into the removable tray. Alternatively, the one or more carrier media may be positioned within a different container or location for absorption of the terpene solution. The end-user may also place the one or more cannabis materials in the bottom of the storage apparatus during the absorption of the terpene solution by the plurality of carrier media, which may be positioned within the container within the removable tray that is situated within the storage apparatus. Alternatively, the end-user may wait until the terpene solution has been absorbed by the one or more carrier media before placing the carrier media within the corresponding container and within the removable tray situated within the storage apparatus. As an example, the plurality of carrier media may be gel beads fabricated from at least sodium polyacrylate. As another example, a carrier medium may be cellulose paper having a particular shape (e.g., square, circle, etc.). (Cellulose paper is just one example of a type of absorbent paper; other substances (e.g., cotton, rice, flax seed, etc.) may be used in addition or in the alternative.)

The terpene solution itself is not limited to any particular formula. For instance, the terpene solution may include a terpene blend of various terpene materials. As an example, the terpene materials may include one or more naturally derived non-cannabis terpene isolates, which are food grade. As another example, the terpene materials may include one or more terpenes extracted from one or more cannabis plants. As yet another example, the terpene materials may form a cannabis/non-cannabis hybrid formulation, including one or more terpenes extracted from one or more cannabis plants and one or more naturally derived non-cannabis terpene isolates.

Furthermore, the terpene blend may include materials other than specific terpenes. For instance, the terpene blend may include one or more essential oils. Additionally, or alternatively, the terpene blend may include one or more flavor enhancers, such as an ester and an aldehyde.

Moreover, one example of the storage apparatus, which shall be illustrated in the accompanying drawings for illustrative purposes, is a wide-mouth mason jar. However, other storage apparatuses may be used instead.

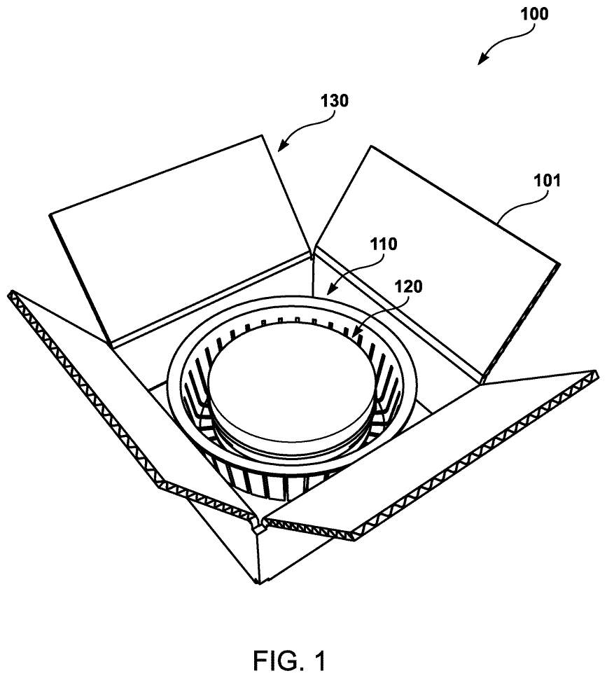

FIG. 1 illustrates an example of a kit configuration 100 that may be utilized for contactless terpene infusion. The kit configuration 100 may have a package 130 (e.g., a box) that encloses the components of the kit. For example, the one or more flaps 101 may be folded to enclose the package 130. (Alternative types of packages than that illustrated in FIG. 1 may be utilized for the package 100.) In one embodiment, the kit configuration 100 has a removable tray 110 and a carrier medium container 120. In particular, the carrier medium container 120 stores one or more carrier media that are configured to at least partially absorb a terpene composition upon making contact with the terpene composition (e.g., solution).

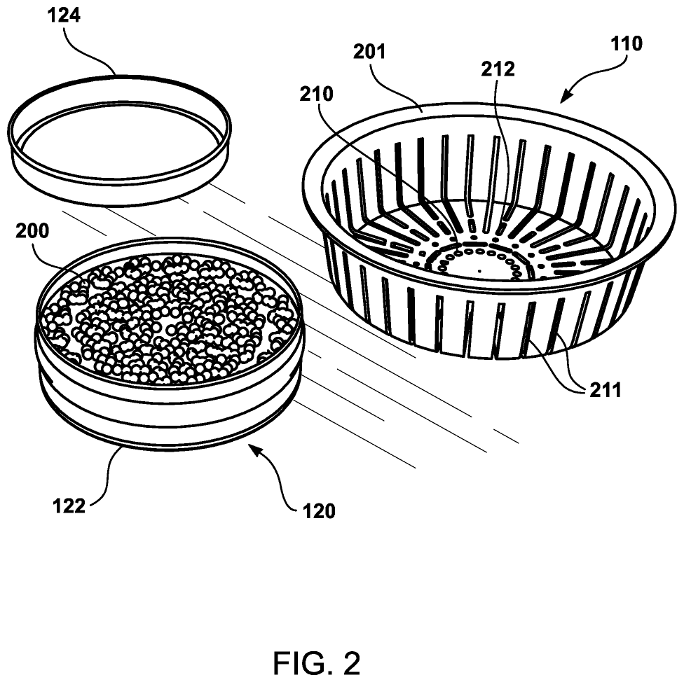

FIG. 2 illustrates the kit configuration 100 as removed from the package 130. The removable tray 110 is specifically adapted to fit within a top portion of a storage apparatus. For example, the removable tray 110 has an upper lip 201 that is configured to mate with an inner rim of a storage apparatus, while still allowing the storage apparatus to be closed with the removable tray positioned therein. Such adaptation prevents the carrier medium from contacting the one or more cannabis materials positioned within the bottom of the storage apparatus.

The removable tray 110 may have a plurality of circular-shaped apertures 210 positioned along a horizontal axis of the removable tray 110. Each of the plurality of circular shaped apertures 210 may be shaped in a substantially similar manner to a horizontal axis cross-section of the carrier medium to emit the aroma from the terpene composition through at least one of the plurality of circular shaped apertures 210 to the one or more cannabis materials. (The term “substantially similar” is intended to connote a similar shape and/or a similar size.) For example, each of the plurality of circular shaped apertures 210 may have a similar shape (e.g., circle) to that of a two-dimensional cross-section of a bead (e.g., circle) such that the bead does not fall through the removable tray 110. The dimensions of the circular shaped aperture 210 may be sized (e.g., via diameter) to be smaller or the same size as the cross section to prevent the bead from falling through. In one embodiment, such sizing is based on the expanded size of the carrier medium. In another embodiment, such sizing is based on the unexpanded size. Such configuration allows for optimal delivery of the terpene aroma in a downward direction toward the one or more cannabis materials because a significant portion of the carrier medium is not blocked by the bottom wall of the removable tray 110 itself. Furthermore, in one embodiment, such configuration helps lock at least some of the plurality of carrier media in place within the removable tray 110 (e.g., a bead mates with a circular shaped aperture 210) to optimally deliver contactless terpene infusion without the carrier media moving around within the removable tray 110, which could impede terpene infusion. In another embodiment, such locking is not utilized.

Additionally, in one embodiment, the removable tray 110 may have a pattern for the plurality of circular shaped apertures 210 that optimizes contactless terpene infusion in a downward direction toward the one or more cannabis materials. For example, the pattern may be a semicircular pattern that allows for dispersion of the terpene aroma in a manner that maximizes terpene exposure around the inside of the storage apparatus. Furthermore, the removable tray 110 may also have a plurality of substantially rectangular shaped apertures 211 are positioned along one or more vertical axes of the removable tray 110. Alternatively, or in addition, a plurality of substantially rectangular shaped apertures 212 are positioned along one or more horizontal axes of the removable tray 110. In one embodiment, the plurality of substantially rectangular shaped apertures 211 may be connected to the plurality of substantially rectangular shaped apertures 212 to integrally form an aperture that is both substantially vertical and horizontal. In another embodiment, the plurality of substantially rectangular shaped apertures 211 is distinct from the plurality of substantially rectangular shaped apertures 212.

Given that locking the carrier media in place along the sides of the removable tray 110 is not readily feasible, the circular shaped apertures 210 are reserved only for the bottom portion of the removable tray 110. The side portions of the removable tray 110 allow for sideways aroma dispersion.

Furthermore, the carrier medium container 120, which may be a cylindrical container, may have a top portion 124 that attaches to a bottom portion 122. For example, the top portion 124 may be a cap that twists on and off of the bottom portion 122 of the carrier medium container 120. The carrier medium container 120 may store a plurality of carrier media 200.

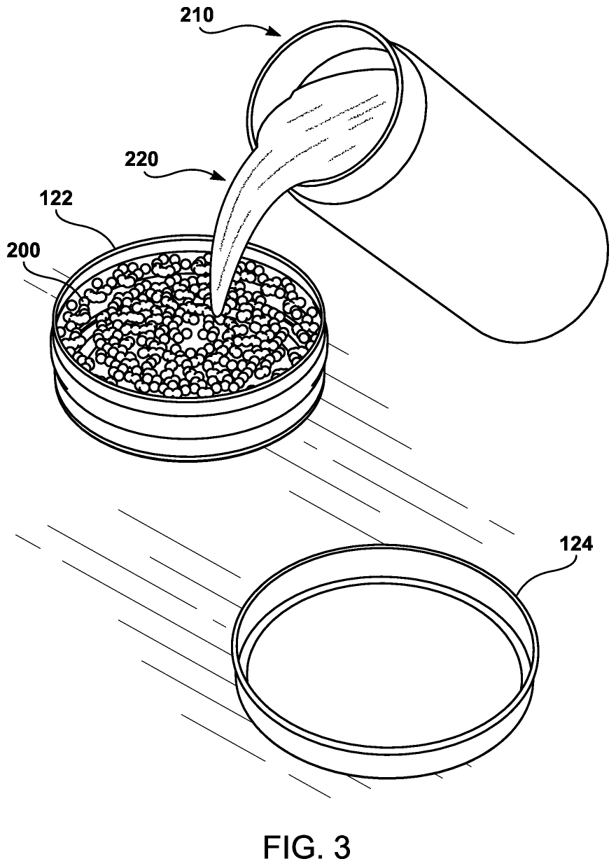

FIG. 3 illustrates a terpene solution 220 being poured from a terpene composition container 210 onto the carrier media 200 within the carrier media container 120. In one embodiment, a human pours the terpene composition. In another embodiment, a machine pours the terpene composition.

Moreover, in one embodiment, the plurality of carrier media 200 is miniaturized at the outset of dispersion. Upon subsequent contact with the terpene solution 220, the plurality of carrier media 200 absorb the terpene solution 220 by expanding in size, thereby carrying the terpene composition without moisture, or with only minimal moisture, in the removable tray 110.

In one embodiment, the terpene composition container 210 and/or the terpene solution 220 are provided separately from the kit 100 illustrated in FIG. 1. In another embodiment, the terpene composition container 210 and/or the terpene solution 220 are provided as part of the kit 100.

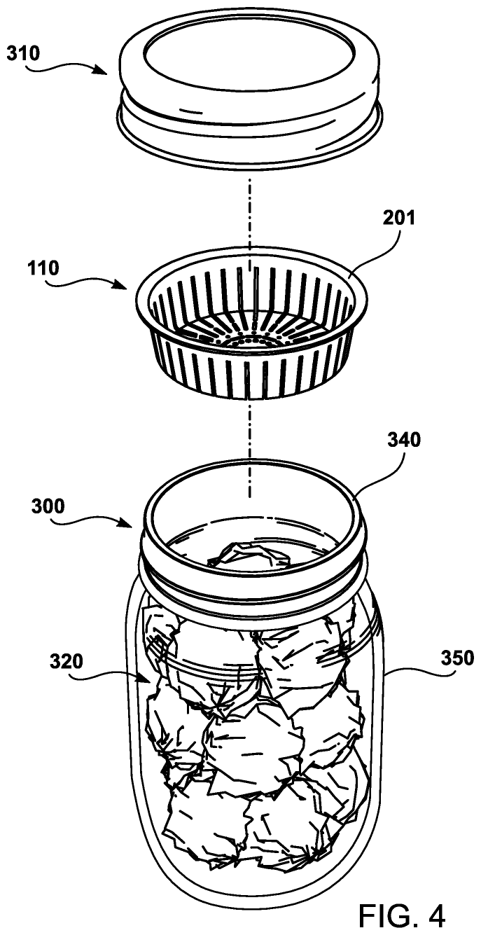

FIG. 4 illustrates a storage apparatus 300 that may be utilized in conjunction with the kit 100 illustrated in FIG. 1. In particular, the storage apparatus 300 may have a storage compartment 350, which may store one or more cannabis materials 320, and a top lid 310 which may enclose the storage apparatus 300. The storage apparatus 300 may have a rim 340 that mates with the lip 201 of the removable tray 110.

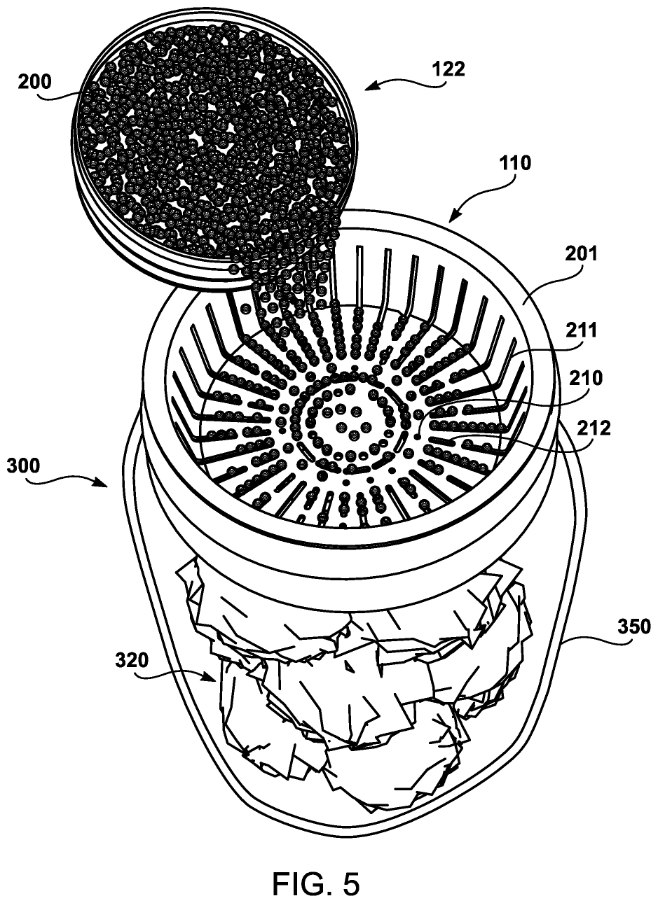

Subsequent to absorption of the terpene solution 220 by the plurality of carrier media 200 within the carrier media container 120, the plurality of carrier media 200 may be poured into the removable tray 110, as illustrated in FIG. 5. (Alternatively, the carrier media container 120 does not have to be utilized during the terpene absorption process.) The plurality of carrier media 200 may fall into position within the plurality of circular shaped apertures 210. Additionally, in another embodiment, the plurality of carrier media 200 may also fall into position with respect to a plurality of substantially rectangular shaped apertures 211 that are placed along the horizontal plane of the removable tray 110 in proximity to the plurality of circular shaped apertures 210. This combination of the plurality of circular shaped apertures 210 and the plurality of substantially rectangular shaped apertures 211 allows for optimal dispersion by potentially locking some carrier media 200 into place for aroma dispersion, while allowing others to provide aroma dispersion via less restriction on movement. In other words, both static and dynamic aroma dispersion is provided for by the different apertures 210 and 211, thereby optimizing downward delivery of the terpene aroma toward the one or more cannabis materials 320. Furthermore, aroma dispersion may be provided for through the vertical rectangular shaped apertures 211 to allow for any terpene aroma that is not directed downward to be dispersed substantially horizontal into the storage apparatus 300.

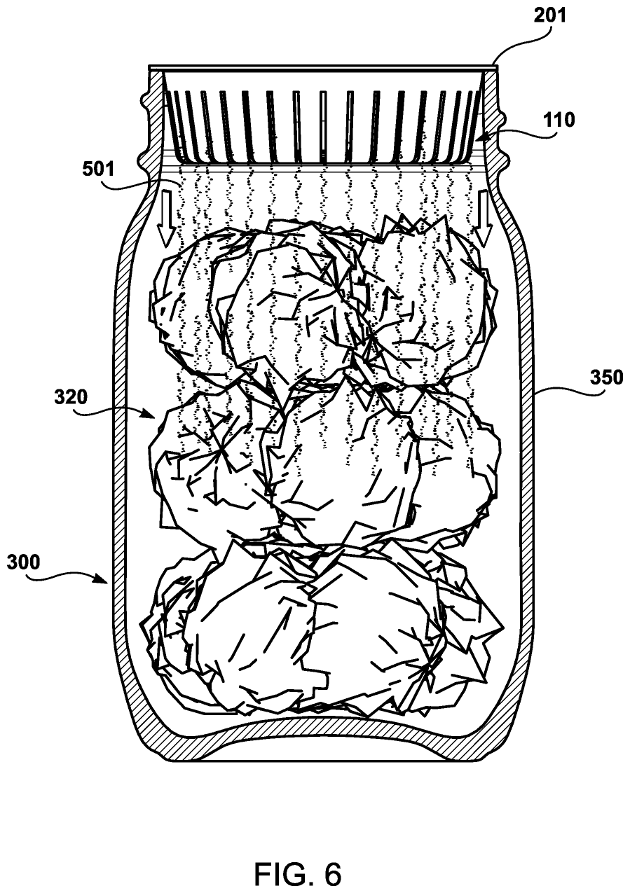

The plurality of carrier media 200 (i.e., expanded beads that have absorbed the terpene solution 220) may emit a terpene aroma 501 downward within the storage apparatus 300 toward the one or more cannabis materials 320, as illustrated in FIG. 6. The top lid 310 of the storage apparatus 300 may be positioned over the removable tray 110 and closed to encapsulate the removable tray 110 and the carrier media 200 within the storage apparatus 300 for contactless terpene aroma emission. Accordingly, the terpene aroma 501 may be emitted downward toward the one or more cannabis materials 320 without the carrier media 200 making contact with the one or more cannabis materials 320, thereby avoiding damage thereto. The top lid 310 is not illustrated for ease of illustration of the aroma dispersion, but may be attached to prevent escape of the aroma from the storage apparatus 300.

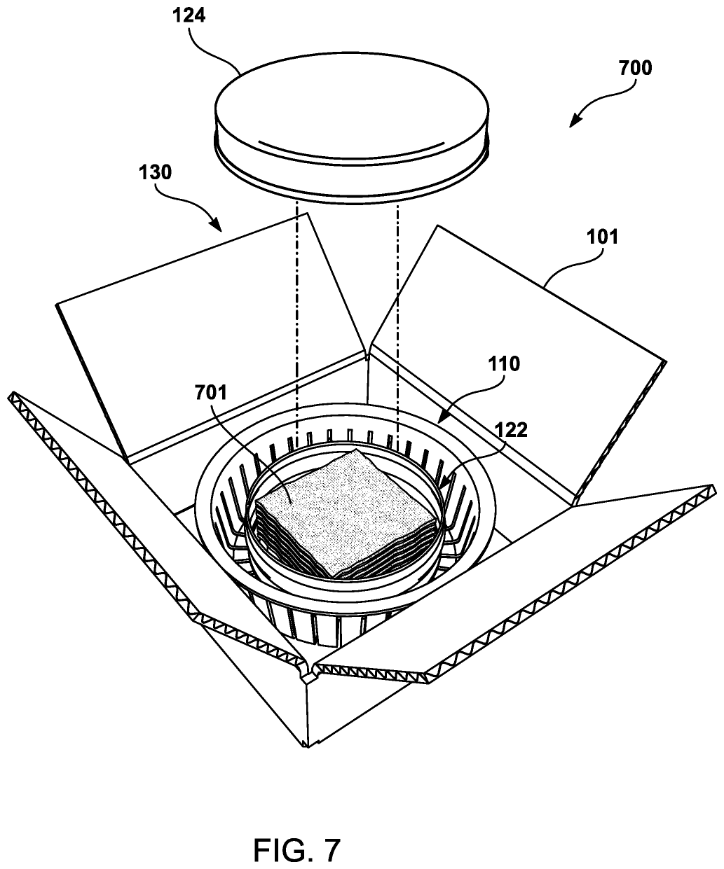

In an alternative embodiment, as illustrated in FIG. 7, an example of another kit configuration 700 that may be utilized for contactless terpene infusion. The kit configuration 700 may have a package 130 (e.g., a box) that encloses the components of the kit. For example, the one or more flaps 101 may be folded to enclose the package 130. (Alternative types of packages than that illustrated in FIG. 1 may be utilized for the package 100.) In one embodiment, the kit configuration 700 has a removable tray 110 and a carrier medium container 120. In particular, the carrier medium container 120 stores one more carrier media 701 that is a stack of square-shaped absorbent paper. (Alternative shapes (e.g., rectangles, circles, triangles, etc.) may be utilized for the absorbent paper. Advantageously, the carrier media 701 are configured to at least partially absorb a terpene composition (e.g., solution) upon making contact with the carrier media 701 without the messiness that would potentially occur with a smaller carrier medium. In other words, the area of the absorbent paper may be configured such that the terpene composition may be poured onto it with minimal or no spillage prior to absorption, since the absorbent paper does not have the gaps that would be present with a plurality of smaller, and more numerous, carrier media used at the same time. Although a stack of carrier media 701 is illustrated, one carrier medium 701 may be utilized one at a time for a given usage period.

The size of the carrier medium 701 may vary to accommodate different sized removable trays 110 and different sized packages 130. For example, the carrier medium may be a two inch by two inch square-shaped absorbent paper that fits within a circular shaped removable tray 110 having a diameter of two and one half inches. (A variety of different sizes and shapes may be used for the carrier medium 701 and/or the removable tray 110.)

Furthermore, the carrier medium 701 may have different thicknesses that allow for various level of absorption of the terpene composition, maximization of aroma emission, minimization or avoidance of spillage of the terpene composition, and a fit within the removable tray 110. In one embodiment, an optimal thickness of the absorbent paper has been determined to be in the range of one tenth of an inch to one quarter of an inch; this range of thicknesses allows for all of the foregoing criteria to be met. By way of contrast, for exemplary purposes, an absorbent paper that has a thickness of one inch may have strong enough absorbent capabilities to avoid spillage, but have the effect of minimization of aroma emission. Furthermore, by way of additional contrast, for exemplary purposes, an absorbent paper that has a thickness of one one hundredth of an inch may allow for significant spillage. Accordingly, the optimal range provided for herein of one tenth of an inch to one quarter of an inch provides an optimal balance to meet the previously mentioned criteria. Although this optimal range has been described herein, absorbent paper that substantially (e.g., within a predetermined threshold deviation of ten to twenty percent) falls within this range may also sufficiently meet the indicated criteria. Further, alternative ranges such as one tenth of an inch to three tenths of an inch, one tenth of an inch to four tenths of an inch, and one tenth of an inch to five tenths of an inch may be utilized.

Although the kit configuration 700 is illustrated as having a plurality of absorbent papers 701, this illustration is provided only for exemplary purposes. For instance, the kit configuration 700 may have just one absorbent paper 701. Furthermore, although the kit configuration 700 is illustrated as having the plurality of absorbent papers 701 stored within the carrier medium container, a carrier medium container 124 is not required. For example, the absorbent papers 701, or other carrier medium, may be directly stored within the package 130, such as within the removable tray 110.

In one embodiment, the terpene composition container 210 and/or the terpene solution 220 are provided separately from the kit 700 illustrated in FIG. 7. In another embodiment, the terpene composition container 210 and/or the terpene solution 220 are provided as part of the kit 700.

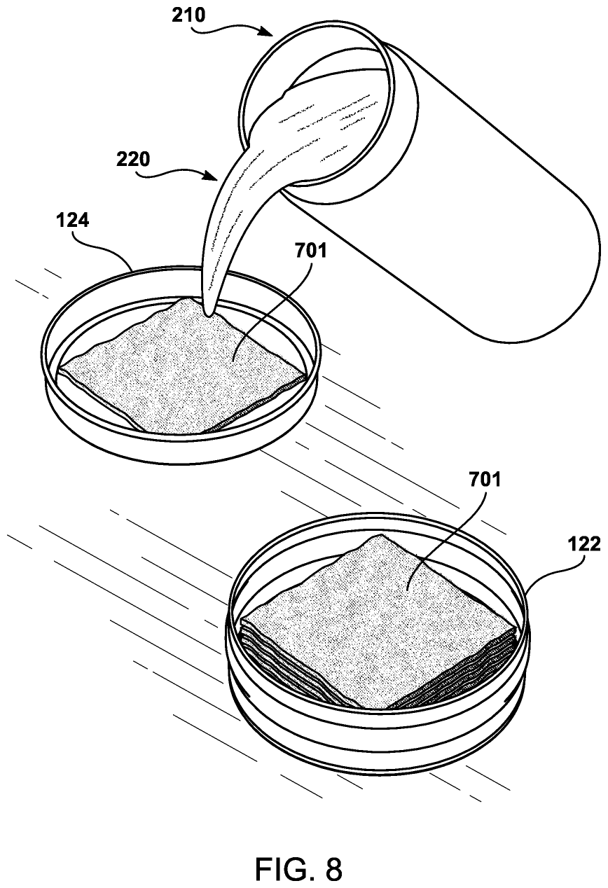

FIG. 8 illustrates a terpene solution 220 being poured from a terpene composition container 210 onto the absorbent paper 701 within the carrier media container 120. (Alternatively, the carrier media container 120 is not required for use with the absorbent paper 701 when the terpene composition is poured.) In one embodiment, a human pours the terpene composition 220. In another embodiment, a machine pours the terpene composition 220. Given the absorbability of the absorbent paper 701, spillage may be minimized. Furthermore, the absorbent paper 701 may allow for minimal absorption time (in the approximate range of one to ten minutes), in contrast with a carrier medium that relies on expansion resulting from the absorption having a more extended time period (e.g., potentially hours or days). Such minimal absorption time allows for quicker usage of the carrier medium 701 for aroma emission.

Upon subsequent contact with the terpene solution 220, the absorbent papers 701 absorbs the terpene solution, thereby carrying the terpene composition without moisture, or with only minimal moisture, in the removable tray 110.

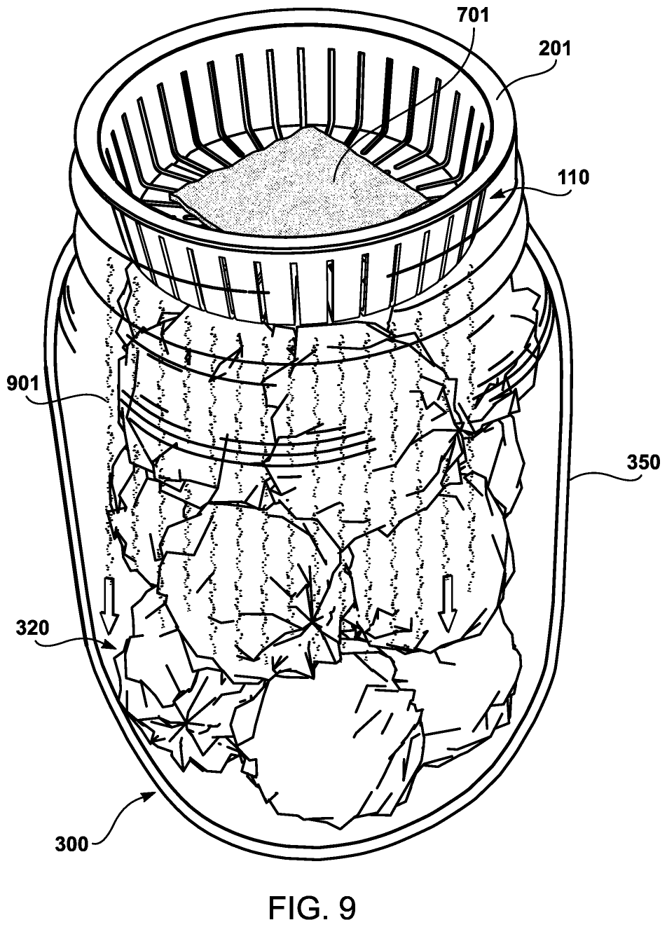

The absorbent paper 701 may emit a terpene aroma 901 downward within the storage apparatus 300 toward the one or more cannabis materials 320, as illustrated in FIG. 9. The top lid 310 of the storage apparatus 300 may be positioned over the removable tray 110 and closed to encapsulate the removable tray 110 and the absorbent paper 701 within the storage apparatus 300 for contactless terpene aroma emission. Accordingly, the terpene aroma 901 may be emitted downward toward the one or more cannabis materials 320 without the absorbent paper 701 making contact with the one or more cannabis materials 320, thereby avoiding damage thereto. Given the optimal range of thickness of the absorbent paper 701, dripping of the terpene composition may be avoided, or at least minimized, to avoid damage to the cannabis materials 320. The top lid 310 is not illustrated for ease of illustration of the aroma dispersion, but may be attached to prevent escape of the aroma from the storage apparatus 300.

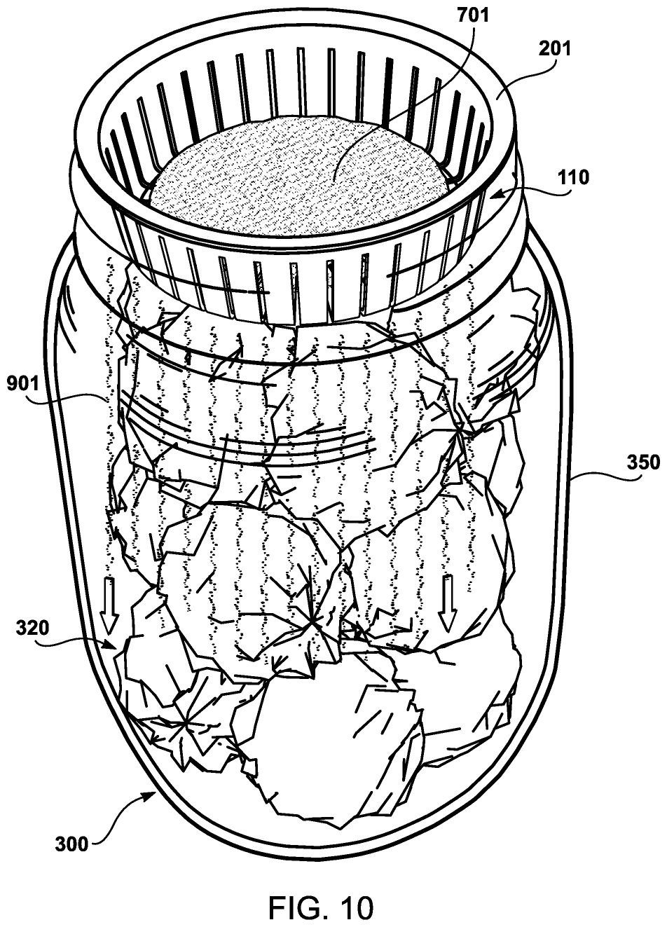

FIG. 10 illustrates the absorbent paper 701 as having a circular shape. In particular, the absorbent paper 701 may have a diameter that is substantially similar (within a ten to twenty percent deviation) to the diameter of the removable tray 110; with such a conforming fit, the terpene aroma 901 is emitted downward, but blocks apertures along the horizontal axis. As a result, the terpene aroma 901 is focused on downward movement with minimal reversionary movement back up through the apertures along the horizontal axis. Accordingly, the aroma emission toward the cannabis materials 320 is enhanced.

The absorbent paper 701 is not limited to enhancing the smell of the cannabis materials 320. In addition, the absorbent paper 701 (or other carrier medium described herein) provides for humidity control within the storage apparatus 300 (particularly when closed). The aroma emitted by the absorbent paper 701 maintains a humidity level within the storage apparatus of slightly dry. This humidity level enhances the absorption of terpenes into the cannabis materials 320, preserves use of the cannabis materials 320, and reduces contamination of the cannabis materials 320.

Although the description and accompanying drawings refer to cannabis materials, other types of materials may be utilized in the alternative or in addition. For example, rolling papers may be utilized with the kits described herein.

Furthermore, in one embodiment, a user utilizes the kits described herein to soak a carrier medium described herein with a terpene solution. However, in another embodiment, the carrier medium may be pre-soaked and provided within the kit such that the user does not have to perform the soaking.

It is understood that the apparatuses and processes described herein may also be applied in other types of apparatuses and processes. Those skilled in the art will appreciate that the various adaptations and modifications of the embodiments of the apparatuses and processes described herein may be configured without departing from the scope and spirit of the present apparatuses and processes. Therefore, it is to be understood that, within the scope of the appended claims, the present apparatuses and processes may be practiced other than as specifically described herein.

We claim:

1. A kit configured to perform contactless terpene infusion for one or more cannabis materials, the kit comprising:
a terpene composition;
a carrier medium that is configured to at least partially absorb the terpene composition upon making contact with the terpene composition; and
a removable tray adapted to (i) fit within a top portion of a container, (ii) receive the carrier medium, (iii) prevent the carrier medium from contacting the one or more cannabis materials situated within a bottom portion of the container, and (iv) infuse the one or more cannabis materials with an aroma from the carrier medium subsequent to the at least partial absorption of the terpene composition.

2. The kit of claim 1, wherein the carrier medium is an absorbent paper.

3. The kit of claim 1, wherein the absorbent paper has a thickness substantially within a range of one tenth of an inch to one quarter of an inch.

4. The kit of claim 1, wherein the carrier medium is a bead fabricated from at least sodium polyacrylate.

5. The kit of claim 4, wherein the bead expands in size to perform the at least partial absorption.

6. The kit of claim 1, wherein the removable tray has a plurality of circular shaped apertures positioned along a horizontal axis of the removable tray, each of the plurality of circular shaped apertures being shaped in a substantially similar manner to a horizontal axis cross-section of the carrier medium to emit the aroma from the terpene composition through at least one of the plurality of circular shaped apertures to the one or more cannabis materials.

7. The kit of claim 6, wherein the plurality of circular shaped apertures are positioned in at least a semicircular pattern along the horizontal axis.

8. The kit of claim 6, wherein each of the plurality of circular shaped apertures are configured to reduce movement of the carrier medium along the horizontal axis.

9. The kit of claim 6, wherein the removable tray has a plurality of substantially rectangular shaped apertures that are positioned along one or more vertical axes of the removable tray.

10. The kit of claim 1, further comprising a cylindrical container that stores the carrier medium prior to at least partial absorption, the cylindrical container configured to fit fully within the removable tray.

11. A kit configured to perform contactless terpene infusion for one or more cannabis materials, the kit comprising:
a terpene composition;
a container storing the terpene solution;
a carrier medium that is configured to at least partially absorb the terpene composition upon making contact with the terpene composition;
a storage apparatus, the storage apparatus comprising:
a bottom portion,
a wall integrally formed to surround the bottom portion, and to extend upward from the bottom portion, and
a top portion that is removable from the storage apparatus, the top portion being in contact with the wall during closure of the storage apparatus; and
a removable tray adapted to (i) fit within the top portion of the storage apparatus, (ii) receive the carrier medium, (iii) prevent the carrier medium from contacting the one or more cannabis materials situated within the bottom portion of the storage apparatus, and (iv) infuse the one or more cannabis materials with an aroma from the carrier medium subsequent to the at least partial absorption of the terpene composition.

12. The kit of claim 11, wherein the carrier medium is an absorbent paper.

13. The kit of claim 11, wherein the absorbent paper has a thickness substantially within a range of one tenth of an inch to one quarter of an inch.

14. The kit of claim 11, wherein the carrier medium is a bead fabricated from at least sodium polyacrylate.

15. The kit of claim 14, wherein the bead expands in size to perform the at least partial absorption.

16. The kit of claim 11, wherein the removable tray has a plurality of circular shaped apertures positioned along a horizontal axis of the removable tray, each of the plurality of circular shaped apertures being shaped in a substantially similar manner to a horizontal axis cross-section of the carrier medium to emit the aroma from the terpene composition through at least one of the plurality of circular shaped apertures to the one or more cannabis materials.

17. A kit configured to perform contactless terpene infusion for one or more cannabis materials, the kit comprising:
a carrier medium that is configured to at least partially absorb a terpene composition upon making contact with the terpene composition;
a removable tray adapted to (i) fit within a top portion of a container, (ii) receive the carrier medium, (iii) prevent the carrier medium from contacting the one or more cannabis materials situated within a bottom portion of the container, and (iv) infuse the one or more cannabis materials with an aroma from the carrier medium subsequent to the at least partial absorption of the terpene composition.

18. The kit of claim 17, wherein the carrier medium is an absorbent paper.

19. The kit of claim 17, wherein the absorbent paper has a thickness substantially within a range of one tenth of an inch to one quarter of an inch.

20. The kit of claim 17, wherein the carrier medium is a bead fabricated from at least sodium polyacrylate.
